(19) United States
(12) Patent Application Publication
(10) Pub. No.: US 2006/0292261 A1
(43) Pub. Date: Dec. 28, 2006

(54) Injection-molding apparatus cleaning system, and injection molding apparatus

(76) Inventor: Herbert Gunther, Allendorf (DE)

Correspondence Address: CLARK & BRODY, 1090 VERMONT AVENUE, NW, SUITE 250, WASHINGTON, DC, 20005, US

(21) Appl. No.: 11/451,381

(22) Filed: Jun. 13, 2006

(30) Foreign Application Priority Data
Jun. 16, 2005 (DE) 10 2005 028 100.1

(51) Int. Cl. B29C 45/20

(52) U.S. Cl. 425/564

(57) ABSTRACT

To keep the shutoff needles (20) of an injection molding apparatus (1) clean during operation, a cleansing unit (10) is used within said apparatus. The injection molding apparatus (1) comprises at least one needle shutoff nozzle feeding a flowable material to a detachable mold insert, the shutoff needle (20) being displaceable by a drive unit into an open position and a closed position. At least one cleansing element (40) geometrically matching the outer surface of the shutoff needle (20) is associated with each needle to remove material clinging to its outer surface (24). The preferably planar cleansing elements (40) are combined into a set of wipers in a housing (11), spacers (14) being configured between two adjacent cleansing elements (40). The housing (11) is affixable on or in the injection molding apparatus (1).

The present invention relates to a cleaning system for injection molds fitted with needle shutoff nozzles, further to an injection molding apparatus.

Needle shutoff nozzles are used in injection molds to feed a flowable material at a predetermined temperature and at high pressure to a detachable mold insert. Most such nozzles are fitted with pneumatically or hydraulically operated shutoff needles periodically opening and closing the gate apertures in the mold insert. This feature makes possible metering doses very accurately, in particular at high operating rates. The flowable material also may be injected in segments, for instance in cascade gating.

Each shutoff needle is supported in axially displaceable manner in the actual molding zone of the injection molding apparatus and is made to pass into the nozzle zone preferably centrally through a flow duct for the material to be processed (see for instance German patent documents DE 32 49 486 C3 or DE 34 03 603 A1). The flow duct terminates in a nozzle orifice element which at its end constitutes a nozzle outlet aperture. In the closed position, the lower end of the shutoff needle enters a sealing receptacle constituted in the nozzle orifice element or in the mold insert.

To guide the shutoff needle in sealed manner, the manifold plate of the injection molding apparatus typically is fitted with a guide bush or a sealing sleeve receiving the cylindrical shank of the shutoff needle (see for instance the patent documents DE 39 26 357 A1 or EP 1 223 020 B1). A cylindrical free space is subtended between the shutoff needle and the bush and during injection molding apparatus operation it receives flowable material whereby the needle is sealed relative to the flow duct. A lubricating effect is attained simultaneously and lowers the friction between the shutoff needle and the bush.

Even when such sealing is optimally designed, the material to be processed will inevitably leak out through the guide or sealing bush on account of the high pressures within the mold and the needle excursions. Once outside, the residues of material will cling to the shutoff needle, thereby not only degrading sealing, but also in the long run potentially hampering the needle's opening and closing motions. Elaborate cleansing and maintenance work ensues.

The objective of the present invention is to circumvent these and further drawbacks of the state of the art and to keep an injection molding apparatus' shutoff needles clean during operation. Another significant objective of the present invention is to create an injection molding apparatus fitted with needle shutoff nozzles of which the shutoff needles are continuously being rid of residues of material especially in the region of the guide bushes and/or sealing sleeves. Cleansing shall be implemented economically using simple means. Another goal is simple handling and long maintenance intervals.

The main features of the present invention are defined in claims 1, 18 and 24. Illustrative embodiments are the objects of claims 2 through 17 and 19 through 23.

The present invention provides—as regards a cleansing system used in an injection molding apparatus which comprises at least one shutoff needle nozzle allowing feeding a flowable material to a detachable mold insert and of which the shutoff needle can be moved by a drive unit into an open and into a closed position—that at least one cleansing element shall be allocated to each shutoff needle to remove material clinging to the outer surface of the shutoff needle. In this manner the injection molding apparatus' shutoff needles are permanently kept clean during operation without entailing laborious or costly maintenance or cleansing work. Residues of material issuing from the injection molding apparatus can be picked up and removed by the cleansing element(s), in other words, said residues no longer can cling to the shutoff needle and interfere with and/or interrupt injection molding apparatus operation.

In a particularly helpful feature, the cleansing element is geometrically matched to the outer surface of the shutoff needle. Any residues clinging to said needle therefore will be reliably picked up and removed continuously, as a result of which the shutoff needle remains clean also over long time intervals and over the entire outside surface. In a further advantageous embodiment mode of the present invention, the cleansing element makes at least segment-wise firm frictional contact with the shutoff needle's outer surface, further enhancing cleansing effectiveness.

Appropriately the cleansing element is fitted with an edge or a rim zone configured near the shutoff needle's outer surface. Consequently the cleansing elements always and reliably shall pick up the material clinging to the outside of the shutoff needle and hence the residues of material issuing from the injection molding apparatus shall always be reliably removed from the shutoff needle.

Advantageous design features are attained by using a flat cleansing element of circular, discoid, annular or strip shape. Such enumeration is not limitative. Illustratively the cleansing element may also be triangular or trapezoidal.

In a further embodiment mode of the present invention, the cleansing element is configured at an angle to the longitudinal axis of the shutoff needle. This feature further improves cleansing because it allows reliably removing even firmly clinging residues of material from the needle surface. Said angle may be between 45 and 135°. Preferably however the cleansing elements are configured perpendicularly to the shutoff needle, whereby the angle between the needle and the cleansing element is 90° and the needle will be cleansed with each excursion. To implement the angular setting, the cleaning element advantageous shall be in the form of a dome, funnel or cone, the shutoff needle passing centrally through the cleansing element.

In a further significant embodiment of the present invention, the cleansing element is fitted with an aperture receiving at least one shutoff needle. As a result said needle may be rid over its entire surface in a single operational step from material clinging to it, this feature enhancing cleansing efficiency.

In order to preclude that the shutoff needles might snag or warp within the cleansing unit, the cleansing elements are fitted with slots or grooves running radially outward from the aperture. This design creates elastic arcs of circle or strip elements which match the shutoff needle's excursion and which, where called for, are able to get out of the way independently of each other.

A contributory factor in this respect is to configure the cleansing elements in radially displaceable manner transversely to the shutoff needle's longitudinal axis. In this manner needle deviations for instance due to thermal expansions can be compensated.

In a further embodiment mode of the present invention, the cleansing element is symmetrical to the shutoff needle's longitudinal axis. This feature also contributed to assuring that at each excursion, the shutoff needle shall be cleansed all-around.

The present invention furthermore calls for two cleansing elements being configured in series as seen in the shutoff needle's longitudinal direction. Said series elements therefore complement one another in their cleansing effectiveness. Advantageously, moreover, two spacers shall be configured between two adjacent cleansing elements. The cavities so subtended between the cleansing elements are able to receive a comparatively large quantity of material removed from the shutoff needle, whereby the cleansing unit's maintenance-free operating time is very long. The cleansing unit need be exchanged or cleaned only when said cavities have been filled with residues of material.

Appropriately the cleansing elements are received in a housing, a support or the like, that illustratively can be affixed on or in the injection molding apparatus or to a clamping plate of the injection molding apparatus.

All the above advantages also are attained when combining an injection molding apparatus with a cleansing unit as defined in claims 1 through 17 for which independent protection is sought.

A further advantageous embodiment mode of the present invention provides that the cleansing unit be mounted on or in a clamping plate of the said injection molding apparatus. As a result the shutoff needle shall be preserved from degradation in affixation or support and in its driven reciprocation. However the cleansing unit assures that the injection material residues clinging to the needle surface shall be permanently removed. In complementary or alternative manner, however, the cleansing unit also may be mounted on or in a manifold plate of the injection molding apparatus. Or the cleansing unit may be configured between the affixation and the manifold plate.

The cleansing unit may be advantageously configured adjacent to a guide or sealing bush for the shutoff needle. Moreover a cleansing unit may be integrated directly into the guide or sealing bush to further simplify the design and handling of the injection molding apparatus.

The related application of an injection molding apparatus' cleansing unit is defined as an independent claim and precludes the needles of needle shutoff nozzles from being contaminated by material issuing from the injection molding apparatus. In the course of its excursion, each shutoff needle moves through the cleansing unit wherein the superposed cleansing elements rid the needles of residues of material. Said residues cannot cling to the needles.

Further features, particulars and advantages are stated in the claims and in the following description of illustrative embodiments shown in the drawings.

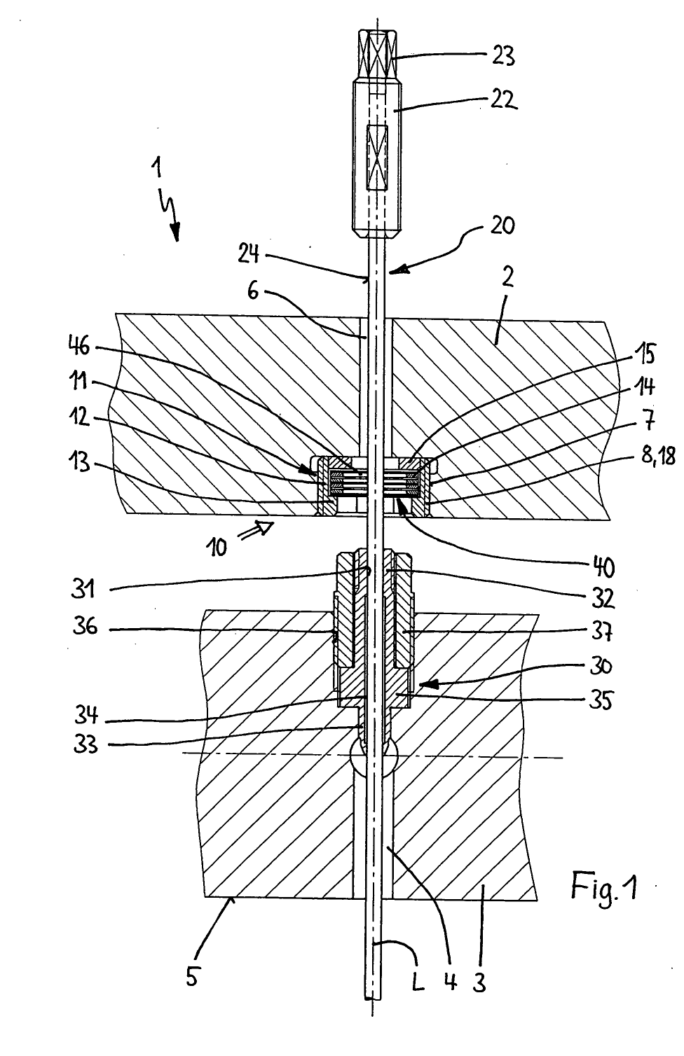

FIG. 1 is a schematic partial view of an injection mold comprising a cleansing unit for a shutoff needle shown partly in section,

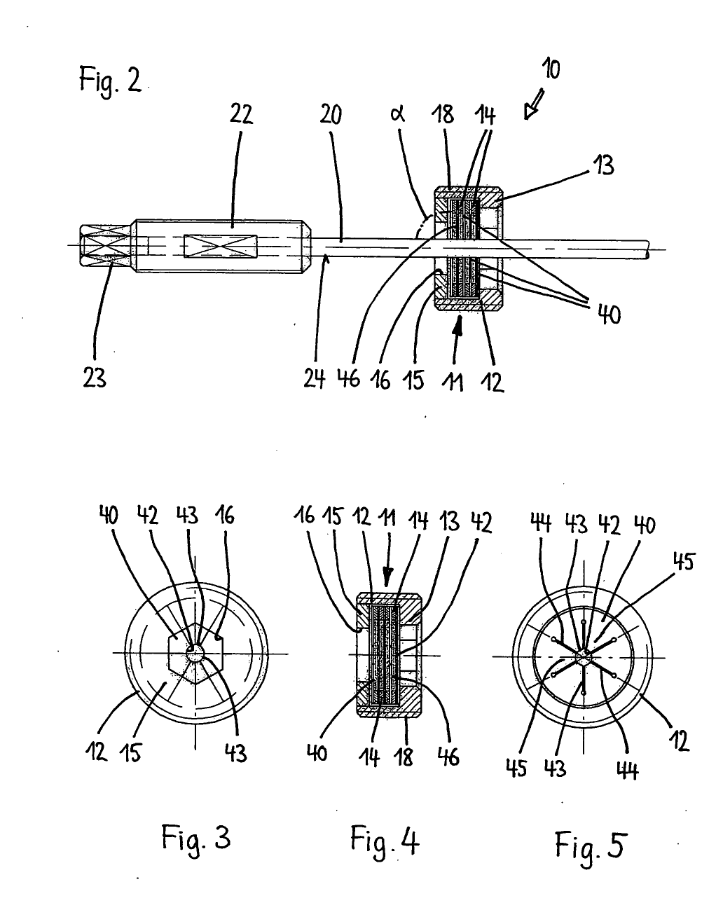

FIG. 2 is an enlarged view of the cleansing unit of FIG. 1 and of the shutoff needle partly shown in section,

FIG. 3 is a topview of the cleansing unit of FIG. 1,

FIG. 4 a sectional sideview of the cleansing unit of FIG. 1, and

FIG. 5 is a bottom view of the cleansing unit of FIG. 1.

The injection molding apparatus denoted overall by 1 in FIG. 1 is used to make molded parts from a flowable material such as a plastic melt. It comprises a clamping plate 2 and parallel thereto a manifold plate 3 fitted with a system of flow ducts 4. Said ducts 4 each issue in an omitted needle shutoff nozzle position or mounted on the underside 5 of the manifold plate 3.

Each needle shutoff nozzle is fitted with a preferably externally heated nozzle case (also omitted) wherein a material duct is situated concentrically with the longitudinal axis L and in continuation of the flow duct 4. Said material flow duct terminates in a nozzle orifice element that constitutes end-wise a nozzle discharge orifice by means of which the material to be processed is guided through a gate aperture a detachable mold insert (also omitted).

A shutoff needle 20 is used to open and close the gate aperture subtended in the mold insert and it passes in longitudinally displaceable manner through the material duct of the needle shutoff nozzle and it can be moved into a closed or open position by means of an omitted mechanical or pneumatic or hydraulic drive unit. In the closed position the shutoff needle 20 enters—by means of a shutoff element (not shown) affixed to its end and through the nozzle discharge orifice—the gate aperture which it seals.

Within the mold-site region, the shutoff needle 20 is connected to the drive unit by means of the manifold plate 3 and the affixing plate 2, said needle 20 supporting at its end an adapter 22 which comprises a cross-sectionally polygonal terminal segment 23 to allow assembling the needle 20 in irrotational manner.

In order to pass the shutoff needle 20, the affixing plate 2 is fitted with a feedthrough borehole 6 of an inside diameter larger than the outside diameter of the shutoff needle 20. A guide bush 30 is seated in the manifold plate 3 and is fitted with a feedthrough borehole 32 of which the inside diameter at the end zones 32, 33 of the bush 30 corresponds to the outside diameter of the shutoff needle except for a slight displacement play. Accordingly said needle 20 will be centrally guided within the bush 30.

A cylindrical clear space 34 is axially subtended between the end zones 32, 33 of the bush 30 of which the inside diameter is slightly larger than the outside diameter of the shutoff needle 20. During operation of the injection molding apparatus, said space receives a slight quantity of flowable material from the flow duct 4 and thereby seals the shutoff needle 20 relative to the flow duct 4 and to the mold surroundings. The flowable material in the free space 34 simultaneously acts as a lubricant and lowers the friction between the shutoff needle 20 and the guide bush 30.

FIG. 1 shows that the guide bush 30 with a widened flange 35 is centrally inserted in a clearance 36 in the manifold plate 3 wherein it is affixed by a screw sleeve 37. The guide bush 30 and also the feedthrough borehole 6 is coaxial with the shutoff needle 20, i.e. with the longitudinal axis L. Illustratively said guide bush is made of a stainless or powder-metallurgical steel and accordingly it is corrosion-proof and wear-resistant. If necessary, however, the bush 30 also may be made of a hard metal.

A cleansing unit 10 servicing the shutoff needles 20 is constituted in the clamping plate 2. Said unit 10 comprises a housing 11 with a cylindrical wall 12 and a terminal, radially inward pointing flange rim 13. Said rim 13 supports several disk-shaped cleansing elements 40 which at their edges are kept equidistant form each other by annular spacers 14 (FIG. 2).

To secure the flat cleansing elements 40 and the spacers 14 inserted between them inside the cleansing unit 10, a securing ring 15 is used which preferably shall be threaded into the housing 11. For that purpose said housing is fitted with an inside thread (not discussed further) whereas the securing ring 15 comprises a corresponding (and also omitted) external thread. A hexagonal socket 16 centrally configured in the securing ring 15 receives a tool to rapidly and conveniently open the housing 11 and to exchange as needed the cleansing elements 40. Alternatively the securing ring 15 (devoid of a thread) is forced into the housing 11 or snapped into the wall 12. The significant feature is that the cleansing elements 40 are exchangeable any time, in other words they can be replaced by new or, depending on the size of the shutoff needle, by other elements 40.

As elucidated in FIGS. 3 through 5, each disk 40 is fitted centrally with an aperture 42 passing the shutoff needle 20. The inside diameter of the aperture 42 is selected in such manner that the rim 43 formed by the aperture 42 is in both geometrically-locking and in frictionally locking contact with the outer surface 24 of the shutoff needle 20. Residues of material clinging to the outside 24 of the shutoff needle 20 and illustratively being expelled or leaking from the guide bush 30 therefore shall be always reliably picked up by the geometrically matching rims 43 of the cleansing elements 40 and removed from the needle 20, in other words the shutoff needle 20 made to pass through the cleansing unit 10, i.e. through the cleansing elements 40, is kept clean during operation of the injection molding apparatus 1 at each reciprocating motion.

To prevent the shutoff needle 20 from snagging or being warped within the cleansing unit 10, for instance due to operationally entailed bending away from the center position defined by the longitudinal axis L, slits 44 are present in the cleansing disks 40 which run radially outward from the aperture 42. The longer said slits 44, the higher the elasticity of the circle segments 45 configured in fan-shaped manner between the radial slits 44. However instead of slits 44, radial grooves also may be fitted into the disks 40, whereby the thickness of the disks 40 shall be less at those grooves and the adjacent segments 45 shall be mutually displaceable.

Moreover each cleansing element 40 can be mounted in the housing 11 in radially displaceable manner between the spacers 14 to stabilize the deflections of the needle 20. This feature assures that the disks 40 match the excursions of the needle 20 and reliably wipe off the contamination clinging to the outside of the needle 20.

Illustratively five cleansing disks 40 are inserted into the housing 11, each subtending an angle of 90° with the longitudinal axis L of the shutoff needle 20.

Depending on the kind of residue of material to be removed, particular or all cleansing elements 40 may have to be configured obliquely at an angle relative to the shutoff needle 20. As a result the rims 43 of the cleansing elements 40 are configured obliquely to the surface 24 of the shutoff needle 20 and therefore are able to reliably always remove hard-clinging contaminant deposits at least in one direction. In such a case the cleansing elements 40 are appropriately conical, domed or funnel like in segments, the shutoff needle 20 centrally passing through each cleansing element 40. The conical-, domed- or funnel-like elements 40 also may be configured in this manner at the rims between spacers 14 in the housing 11. The angle a subtended by the elements 40 and the needle 20 illustratively may be between 45 and 135°, illustratively being 60°.

In the present embodiment mode, assembly of the cleansing unit 10—which as a whole is symmetrical with respect to the longitudinal axis L of the shutoff needle 20—takes place within the feedthrough borehole 6 which is fitted with an enlarged clearance 7 in the edge zone of the clamping plate 2. Said clearance 7 is fitted with a thread 8 at its inside diameter of which the magnitude is such that a housing 11 fitted with a matching external thread 18 can be screwed into the clearance 7 which is coaxial with the feedthrough borehole 6. Omitted engaging elements are constituted for that purpose in the flange edge 13 of the housing 11 to allow applying a torque by means of a suitable tool to the housing 11. In the assembled position, the securing ring 15 rests at the inside against the bottom (not further elucidated) of the clearance 7. Accordingly all cleansing elements 40 are always reliably secured in the housing 11.

The preferably metallic cleaning elements 40 act as wipers on the shutoff needle 20, in particular as a wiper set, that is, any residues of material clinging to the shutoff needle 20 are engaged by the disk edges 43 and picked up by the cleansing unit 10, without entailing interruption of injection molding. The material removed from the outside 24 of the shutoff needle 20 is collected in the cavities 46 subtended by the spacers 14 between the cleansing disks 40. As a result, the cleansing unit 10 also may be operated over a substantial length of time in problem-free manner. Cleansing and maintenance work is minimized.

Be it borne in mind that the cleansing unit 10 as a whole is designed to be coaxial with the shutoff needle 20 and is configured in the immediate vicinity of the guide bush 30. The material leaking/issuing from said bush is therefore immediately picked up by the cleansing unit 10 and removed from the needle 20. This needle is able to freely slide to-and-fro in the guide bush 30 without thereby degrading the sealing effectiveness of the guide bush 30. The entire injection molding apparatus 1 always operates cleanly and reliably.

The invention is not limited to one of the above described embodiment modes, instead it may be modified in versatile manner. Illustratively the cleansing elements 40 are not restricted to being annular panes, they also may be in the form elongated strip elements for instance configured in angularly offset manner between the spacers. However the flat cleansing elements 40 also may be mounted individually or in sets directly on the underside of the clamping plate 2 or at the top of the manifold plate 3. Each time the significant factor applies the that edges 43 of the cleansing elements 40 facing the shutoff needle 20 either match the contour of the outside surface 24 in geometrically hugging manner and/or rest against said outside in frictionally locking manner.

The wiper edges 43 of the disk-shaped or strip-shaped cleansing elements 40 may be bent off further in order to enhance cleansing efficacy even more, the bent edges where called for also pointing in alternating directions.

Further advantages are attained when integrating the cleansing unit 10 with the housing 11 as a whole or with particular cleansing elements 40 in the guide bush 30.

Preferably the cleansing elements 40 are metallic. Plastic however also may be used provided it be physically, chemically and thermally resistant to the injection molding material to be processed.

In a further embodiment mode of the invention, separate wiper elements or bristles may be deposited on the edges 43 of the cleansing elements 40 to make direct contact with the outside 24 of the shutoff needle 20. The cleansing elements 40 per se may be made of plastic whereas the deposited edge elements are made of metal, or vice-versa.

In still another alternative embodiment mode, two or more shutoff needles 20 run through each cleansing element 40, this feature being especially advantageous when the cavity separations and hence the shutoff needles 20 are situated very close to each other in the injection mold. In this case the cleansing elements 40 are fitted with the corresponding number of apertures 42.

The cleansing unit 10 need not mandatorily be screwed into the clamping plate 2. The housing 11 also may be inserted and then be secured by a separate securing element against dropping out, for instance using a securing ring, screws or clamping elements. Conceivably too, the cleansing unit 10 may be mounted externally on the clamping plate 2 and be affixed in place by retainer flanges or brackets. Or the cleansing unit 10 might be affixed to the manifold plate 3.

In order to further enhance cleansing, the cleansing unit 10 and/or the cleansing elements 40 may be rotary relative to the shutoff needle 20. In complementary manner or alternatively, the cleansing unit 10 also may carry out its own excursion relative to the shutoff needle 20.

Be it borne in mind that a cleansing unit 10 is configured within the injection molding apparatus 1 to keep the shutoff needles 20 of said apparatus clean during operation. The injection molding apparatus 1 comprises at least one needle shutoff nozzle allowing feeding a flowable material to a detachable mold insert, the shutoff needle 20 being displaced by a drive unit into an open and a closed position. At least one cleansing element 40 geometrically matching the outside surface 24 of the shutoff needle 20 is allocated to each shutoff needle and allows removing material clinging to said outside surface. The preferably flat cleansing elements 40 are combined into a set of wipers in a housing 11, spacers 14 being configured between two adjacent cleansing elements 40. The housing 11 may be affixed on or in the injection molding apparatus 1.

All features and advantages contained in the claims, the description and drawing, inclusive design details, spatial configurations and process steps, may be construed being inventive per se or in arbitrary combinations.

List of Reference Numerals

L longitudinal axis
1 injection molding apparatus
2 clamping plate
3 manifold plate
4 flow duct
5 underside
6 feedthrough borehole
7 recess
8 inside thread
10 cleansing unit
11 housing
12 wall
13 flange rim
14 spacer
15 securing ring
16 clearance
18 external thread
20 shutoff needle
22 adapter
23 Terminal segment
24 outer surface
30 guide bush
31 feedthrough borehole
32 end zone
33 end zone
34 clear space
35 flange
36 clearance
37 screw bolt
40 cleansing element
42 aperture
43 edge
44 radial slit
45 circle segment
46 cavity

1. A cleansing unit (10) for an injection molding apparatus (1) that comprises at least one needle shutoff nozzle feeding a flowable material to a detachable mold insert, and of which the shutoff needle (20) can be moved by a drive unit into an open position and a closed position, characterized in that at least one cleansing element (40) is allocated to each shutoff needle (20) and allows removing material clinging to the outer surface (24) of the shutoff needle (20).

2. Cleansing unit as claimed in claim 1, characterized in that the shape of the cleansing element (40) matches the shape of the outer surface (24) of the shutoff needle (20).

3. Cleansing unit as claimed in claim 1, characterized the cleansing element (40) makes contact in at least segment-wise, frictionally locking manner with the outside surface (24) of the shutoff needle (20).

4. Cleansing unit as claimed in claim 1, characterized in that the cleansing element (40) comprises an edge (43) or an edge zone configured adjacently to the outer surface (24) of the shutoff needle (20).

5. Cleansing unit as claimed in claim 1, characterized in that the cleansing element (40) is planar.

6. Cleansing unit as claimed in claim 1, characterized in that the cleansing element (40) is circular, discoid, annular or strip-like.

7. Cleansing unit as claimed in claim 1, characterized in that the cleansing element (40) subtends, or is set at, an angle (α) with/relative to the longitudinal axis (L) of the shutoff needle (20).

8. Cleansing unit as claimed in claim 7, characterized in that the angle (α) is between 45 and 135°, preferably 90°.

9. Cleansing unit as claimed in claim 7, characterized in that the cleansing element (40) is domed, conical or funnel-like, the shutoff needle (20) running centrally through the cleansing element (40).

10. Cleansing unit as claimed in claim 1, characterized in that the cleansing element (40) comprises at least one aperture (42) receiving at least one shutoff needle (20).

11. Cleansing unit as claimed in claim 10, characterized in that the cleansing element (40) is fitted with radial slits (44) or grooves starting from the aperture (42).

12. Cleansing unit as claimed in claim 1, characterized in that the cleansing elements (40) are radially displaceable transversely to the longitudinal axis (L).

13. Cleansing unit as claimed in claim 1, characterized in that the cleansing element (40) is symmetrical to the longitudinal axis (L) of the shutoff needle (20).

14. Cleansing unit as claimed in claim 1, characterized in that at least two cleansing elements (40) are sequentially mounted in the longitudinal direction (L) of the shutoff needle (20).

15. Cleansing unit as claimed in claim 14, characterized in that spacers (14) are configured between two adjacent cleansing elements (40).

16. Cleansing unit as claimed in claim 1, characterized in that the cleansing elements (40) are mounted in a housing (11), in a support or the like.

17. Cleansing unit as claimed in claim 16, characterized in that the housing (11) is affixable on or in the injection molding apparatus (1).

18. An injection molding apparatus (1) comprising a cleansing unit (10) as claimed in claim 1.

19. Injection molding apparatus as claimed in claim 18, characterized in that the cleansing unit (10) is mounted on or in a clamping plate (2) of the injection molding apparatus (1).

20. Injection molding apparatus as claimed in claim 18, characterized in that the cleansing unit (10) is mounted at or in a manifold plate (3) of the injection molding apparatus (1).

21. Injection molding apparatus as claimed in claim 18, characterized in that the cleansing unit (10) is mounted between the clamping plate (2) and the manifold plate (3).

22. Injection molding apparatus as claimed in claim 18, characterized in that the cleansing unit (10) is mounted adjacently to a guide or sealing bush (30) for the shutoff needle (20).

23. Injection molding apparatus as claimed in claim 18, characterized in that the cleansing unit (10) is integrated into the guide or sealing bush (30).

24. Application of a cleansing unit (10), in particular as claimed in claim 1, to an injection molding apparatus (1).
